(19) United States
(12) Patent Application Publication
(10) Pub. No.: US 2017/0261739 A1
(43) Pub. Date: Sep. 14, 2017

(54) MULTI-PASS MICROSCOPY

(71) Applicants: Philipp Haslinger, (US); The Board of Trustees of the Leland Stanford Junior University, Stanford, CA (US)

(72) Inventors: Thomas Juffmann, Stanford, CA (US); Brannon B. Klopfer, Stanford, CA (US); Philipp Haslinger, Berkeley, CA (US); Mark A. Kasevich, Stanford, CA (US)

(21) Appl. No.: 15/454,322

(22) Filed: Mar. 9, 2017

Related U.S. Application Data
(60) Provisional application No. 62/306,431, filed on Mar. 10, 2016.

(51) Int. Cl. G02B 21/36; G02B 17/00; G02B 17/08; G02B 21/08

(52) U.S. Cl. CPC G02B 21/361; G02B 21/088; G02B 17/004; G02B 17/08

(57) ABSTRACT

A measurement system includes a focused light source, a first mirror, a plurality of first lenses, a second mirror, a plurality of second lenses and an imaging device. The first mirror is positioned on a first side of a sample and configured to receive light from the light source. The plurality of first lenses are positioned between the first mirror and the sample. The second mirror is positioned on a second side of the sample. The plurality of second lenses are positioned between the second mirror and the sample. The imaging device is positioned adjacent to the second mirror and configured to receive the light from the light source after the light propagates a number of propagations between the first mirror and the second mirror, and through the first lenses and the second lenses.

### CROSS-REFERENCE TO RELATED APPLICATION

This application claims the benefit of and priority to U.S. Provisional Application No. 62/306,431, entitled “Multi-pass Microscopy,” filed Mar. 10, 2016, the content of which is incorporated herein by reference in its entirety.

### TECHNICAL FIELD

The present disclosure relates to systems and methods for multi-pass microscopy and more particularly to systems and methods for providing a pulsed light from a light source to a cavity and collecting a portion of the pulsed light on an imaging device at multiple times.

### BACKGROUND

In many cases, the accuracy of measurements using microscopy is limited by a number of probe particles that can be detected. For example, microscopy of biological or other specimens can require low light levels to avoid damage. Low light yields images impaired by shot-noise, which limits an amount of information that can be obtained from such images. Thus, improvements in such microscopy measurements are desired.

### SUMMARY

In one aspect, a measurement system may include a focused light source, a first mirror positioned on a first side of a sample and configured to receive light from the light source, a plurality of first lenses positioned between the first mirror and the sample, a second mirror positioned on a second side of the sample, a plurality of second lenses positioned between the second mirror and the sample, and an imaging device adjacent to the second mirror. The imaging device may be configured to receive the light from the light source after the light propagates a number m of times between the first mirror and the second mirror, and through the first lenses and the second lenses.

In one aspect, a method may include providing a pulsed light from a light source to a cavity. The cavity may include an ordered parallel arrangement of a first mirror, a plurality of (e.g., two) first lenses, a sample, a plurality of (e.g., two) second lenses, and a second mirror. The cavity may have a round-trip light traversal time. A portion of the pulsed light may be collected on an imaging device at multiple times. The collecting may be performed at a shutter opening of the imaging device. The shutter opening may be periodic with a period duration of greater than the round-trip light traversal time.

In one aspect, a method may include providing a pulsed light from a light source to a cavity. The cavity may include an ordered parallel arrangement of a first mirror, a plurality of (e.g., two) first lenses, a sample, a plurality of (e.g., two) second lenses, and a second mirror. The cavity may have a round-trip light traversal time. A portion of the pulsed light may be collected on an imaging device at a selected time.

Other aspects and embodiments of the disclosure are also encompassed. The foregoing summary and the following detailed description are not meant to restrict the disclosure to any particular embodiment but are merely meant to describe some embodiments of the disclosure.

### BRIEF DESCRIPTION OF THE DRAWINGS

For a better understanding of the nature and objects of some embodiments of this disclosure, reference should be made to the following detailed description taken in conjunction with the accompanying drawings.

FIG. 1 is a schematic diagram illustrating a measurement system according to some embodiments.

FIG. 2A illustrates micrographs representing different numbers of interactions with a quartz-silica depolarizer, according to some embodiments.

FIG. 2B illustrates measured and calculated ratio of a detected number of photons to a detected number of photons without a polarization analyzer, according to some embodiments.

FIG. 2C illustrates measured and calculated variance reduction in multi-pass microscopy for different numbers of interactions, according to some embodiments.

FIG. 3A illustrates the optical density and variance reduction with different numbers of interactions in photon counting measurements of an optical density filter, according to some embodiments.

FIG. 3B illustrates multi-pass microscopy images of hexagonal hole patterns in a carbon membrane, according to some embodiments.

FIG. 3C illustrates multi-pass microscopy images of diffraction patterns in a carbon membrane, according to some embodiments.

FIG. 3D illustrates multi-pass micrographs of embryonic kidney 293T cells, according to some embodiments.

FIG. 4 is a flowchart showing operations of an example multi-pass microscopy method according to some embodiments.

FIG. 5 is a flowchart showing operations of an example multi-pass microscopy method according to some embodiments.

### DESCRIPTION

The present disclosure describes techniques for signal amplification and enhancement.

In measurements using microscopy according to some embodiments, a minimum variance of a phase measurement may be 1/N, if N uncorrelated photons are used for the measurement. In some embodiments, quantum enhanced microscopy can exploit correlations between N probe particles, such as entanglement or squeezing, to decrease the variance of a phase estimate to 1/N², the so-called Heisenberg limit. However, these correlations may be difficult to generate.

In some embodiments, the Heisenberg limit can be reached without entanglement, if the probe particle interacts with a specimen multiple (m) times sequentially, leading to a 1/m² scaling of the variance of a phase shift measurement. In some embodiments, this interaction combined with self-imaging cavities can provide for full field multi-pass polarization and transmission micrographs with variance reductions of, for example, 11.8±0.9 decibels (dB) (15 fold) and 5.0±0.2 dB (3.1 fold) compared to the single-pass shot-noise limit.

In the present disclosure, contrast enhancement capabilities in imaging and in diffraction studies using multi-pass microscopy according to some embodiments are demonstrated with nanostructured samples as well as with embryonic kidney 293T cells. The results show an approach to Heisenberg limited microscopy that does not rely on quantum state engineering.

Sub-shot-noise limited microscopy can be demonstrated in scanning configurations applying NOON states (e.g., a quantum-mechanical many-body entangled state) or squeezed light, and full field shadow imaging can be demonstrated using entangled photons from parametric down-conversion. Experimentally, these techniques may rely on post-selection and the reduction in variance may be less than 3.3 dB, mainly due to difficulties in creating the necessary correlations between the photons.

In some embodiments, in terms of quantum resources (e.g., the number of probe-sample interactions N), the Heisenberg limit can be reached by applying a single probe particle multiple m=N times sequentially, which represents an optimal approach to parameter estimation. In this way, in some embodiments, a variance reduction of more than 10 dB can be achieved in a phase shift measurement. In some embodiments, contrast enhancement in full field double-pass transmission microscopy can be demonstrated using a phase conjugated mirror to pass light twice through a sample. In some embodiments, these techniques can be generalized to full field multi-pass microscopy by placing a sample in a self-imaging cavity.

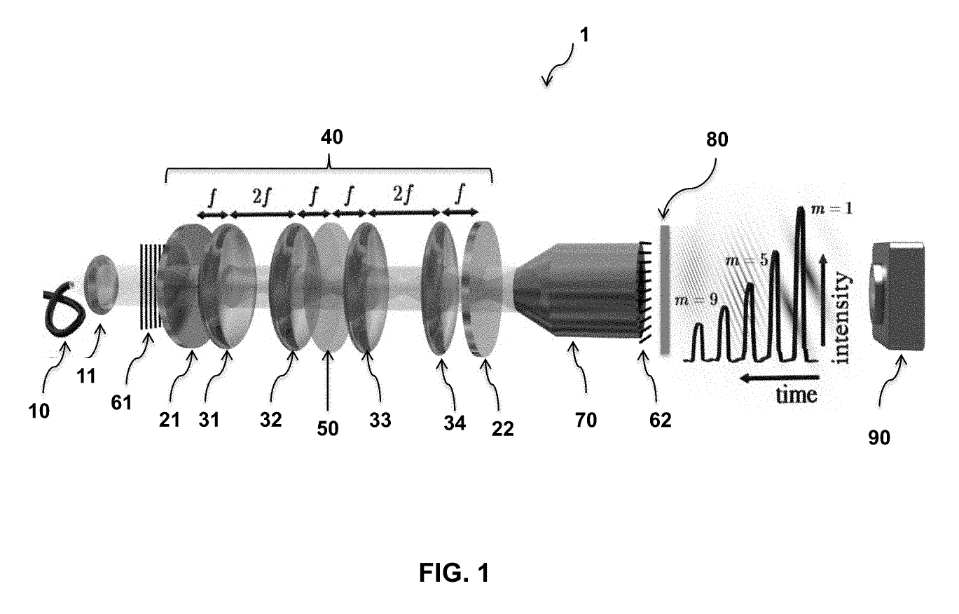

FIG. 1 is a schematic diagram illustrating a measurement system 1 according to some embodiments.

In FIG. 1, in some embodiments, a pulse of light is emitted from a single mode fiber (SMF) 10. In some embodiments, a pulse of light is emitted from a light source 11. In some embodiments, the pulse of light is coupled into a cavity 40 by an in-coupling mirror 21 (or denoted by Mᵢ). In some embodiments, four lenses 31, 32, 33, 34 (or denoted by L_{1 . . . 4}) form a microscope on either side of a sample 50 (or denoted by S), with focal lengths shown as approximately multiples of a focal length f. In some embodiments, after the first light-sample interaction, an image can be formed on an out-coupling mirror 22 (or denoted by Mₒ). In some embodiments, most of the light can be reflected back onto the sample 50 (or denoted by S), which is now illuminated by an image of itself. In some embodiments, an image of enhanced contrast can then be formed on the mirror 21 (or denoted by Mᵢ) and can again be reimaged onto the sample 50 (or denoted by S). In some embodiments, this re-imaging is repeated multiple times. In some embodiments, every time an image is formed on the mirror 22 (or denoted by Mₒ), a fraction of the light can be out-coupled and imaged using a microscope objective 70 onto a gated intensified charge coupled device (ICCD) camera 90. In some embodiments, diffraction patterns can be imaged in the Fourier plane 80 (or denoted by F). For polarization microscopy, in some embodiments, crossed polarizers 61 and 62 (or denoted by Pᵢ and Pₒ) are added.

In some embodiments, a gating time of the ICCD camera 90 (e.g., 150 picoseconds (ps)) may be much shorter than a cavity roundtrip time (e.g., 2.7 nanoseconds (ns)), such that for any given image post-selection is limited to light that interacted with the sample m times. In comparison to cavity enhanced measurements conducted with continuous light sources, in some embodiments, counting the number of interactions allows for a large dynamic range. In some embodiments, the self-imaging cavity allows for faster acquisition times due to the full field of view and further allows for easy access to the sample plane. In some embodiments, as shown in FIG. 1, an illustration of integrated detected intensity as a function of time can be overlaid with simulated images corresponding to the respective intensity peaks.

It should be understood that the setup shown in FIG. 1 is not limiting, and additional modifications are envisioned. For example, although the sample S is shown in FIG. 1 as being positioned between lens L₂ and lens L₃, in other embodiments, the sample S can be placed directly on one of the mirrors Mᵢ or Mₒ. For another example, relative distances between the components in the cavity (e.g., mirrors Mᵢ, Mₒ, and lenses L_{1 . . . 4}) are shown in FIG. 1 by way of example as specific multiples (e.g., 1 or 2) of the focal length f; however, in other embodiments, lenses with different focal lengths may be used, and the distances between two components correspond to the focal lengths of the selected lenses (which may each have different focal lengths). For a further example, although magnification is described, demagnification may be achieved depending on the focal lengths and arrangement of the lenses. Moreover, fewer than four lenses, or more than four lenses, may be included in the setup.

Referring to FIG. 1, in some embodiments, a measurement system includes a focused light source 11, a first mirror 21, a plurality of first lenses 31, 32, a second mirror 22, a plurality of second lenses 33, 34, and an imaging device (e.g., the ICCD camera 90). In some embodiments, the first mirror 21 is positioned on a first side of a sample 50 and configured to receive light from the light source 11. In some embodiments, the plurality of first lenses 31, 32 are positioned between the first mirror 21 and the sample 50. In some embodiments, the second mirror 22 is positioned on a second side of the sample 50. In some embodiments, the plurality of second lenses 33, 34 are positioned between the second mirror 22 and the sample 50. In some embodiments, the imaging device 90 is adjacent to the second mirror 22 and may be configured to receive the light from the light source after the light propagates a number m of times between the first mirror 21 and the second mirror 22, and through the first lenses 31, 32 and the second lenses 33, 34. In some embodiments, the plurality of first lenses are two first lenses 31, 32, and a distance (e.g., 2f) between the two first lenses 31, 32 is approximately equal to twice a distance (e.g., f) between the first mirror 21 and one lens 31 of the two first lenses. In some embodiments, a distance (e.g., 3f) between the first mirror 21 and the other lens 32 of the two first lenses is approximately three times the distance (e.g., f) between the first mirror 21 and the one lens 31 of the two first lenses. In some embodiments, a distance (e.g., f) between a prospective location of the sample 50 and one lens 32 of the first lenses is approximately equal to a distance (e.g., f) between the first mirror 21 and the other lens 31 of the first lenses. In some embodiments, the measurement system 1 further includes a cavity 40 including the first mirror 21, the second mirror 22, the first lenses 31, 32 and the second lenses 33, 34. In some embodiments, the light source 11 may be a pulsed light source. In some embodiments, temporal widths of pulses of light from the light source 11 may be shorter than a round-trip time of light traversing the cavity 40. In some embodiments, the imaging device 90 may be configured to collect, at a shutter opening of the imaging device 90, a portion of the pulsed light on the imaging device 90 at multiple times. In some embodiments, the shutter opening may be periodic with a period duration of greater than the round-trip time of light traversing the cavity.

To demonstrate contrast enhancement and sub-shot-noise imaging, in some embodiments, a wedged quartz-silica depolarizer can be placed in the sample plane S. In some embodiments, every interaction with the quartz crystal may lead to a rotation of the polarization vector on the Poincaré sphere. In some embodiments, for a properly cut and oriented quartz crystal, a detected number of photons Nₘ in a cross polarized setup may be expected to be Nₘ=−N_{m,0} sin²(mη/2). N_{m,0} is a number of photons detected without a polarization analyzer (e.g., the crossed polarizer Pₒ) and η is the retardance of the sample S, which is proportional to the local thickness of the wedged quartz crystal.

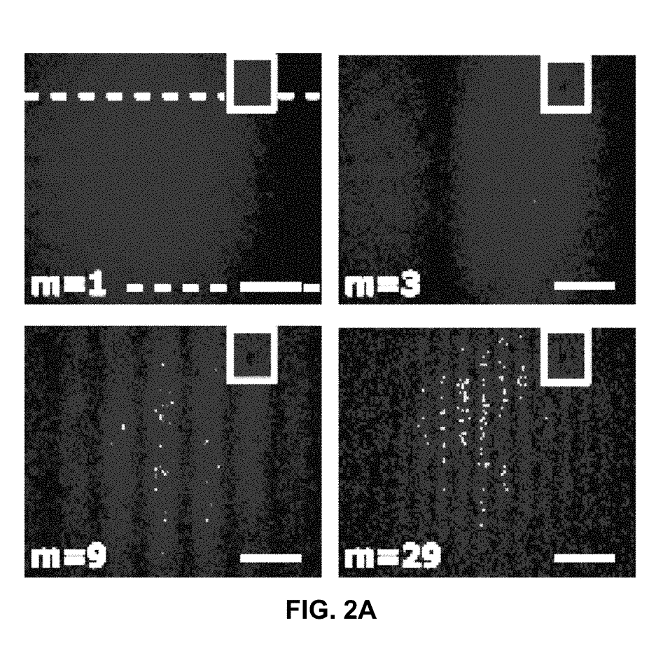

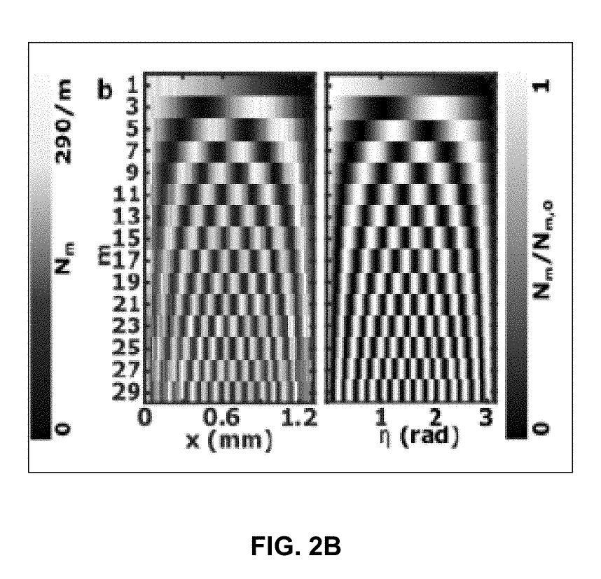

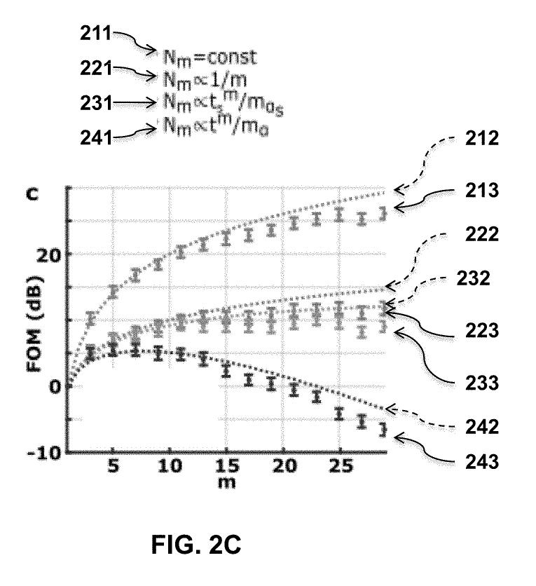

FIG. 2A illustrates micrographs representing different numbers of interactions with a quartz-silica depolarizer, according to some embodiments. FIG. 2B illustrates measured and calculated ratio of a detected number of photons to a detected number of photons without a polarization analyzer, according to some embodiments. FIG. 2C illustrates measured and calculated variance reduction in multi-pass microscopy for different numbers of interactions, according to some embodiments.

FIG. 2A illustrates micrographs representing m=1, 3, 9 and 29 interactions with a quartz-silica depolarizer (scale bar represents 250 micrometers (μm)), according to some embodiments. The inset data was taken without crossed polarizer and shows a dark spot, probably a piece of dust, reimaged onto itself m times.

As shown in FIG. 2A, while upon a single interaction the transmitted intensity varies slowly across the field of view, more rapid signal oscillations are observed for m=1, 3, 9 and 29 interactions, according to some embodiments.

FIG. 2B compares the measured (left) and calculated (right) ratio of Nₘ/N_{m,0}. As seen in FIG. 2B, a normalized number of photons per column (left) agrees well with an expected signal (right). In some embodiments, for each image, N₁α_{P}_{ₒ}_{,m}/m photons were collected, where α_{P}_{ₒ}_{,m} is an averaged fraction of light blocked by the crossed polarizer Pₒ. In some embodiments, assuming a lossless cavity and sample, this can result in an equal number of photon sample interactions and thus also an equal amount of light-induced damage.

FIG. 2C plots “measured” variance reduction data curves (error bars) 213, 223, 233, 243 and “calculated” variance reduction data curves (dashed lines) 212, 222, 232, 242 in multi-pass microscopy for different numbers of collected photons, where error bars give the standard deviation of the variance obtained from bootstrapping.

In some embodiments, the noise on the number of detected photons per pixel will lead to a variance of an estimate of η. In some embodiments, error propagation yields

$${( {Δη}_{m} )}^{2} = {( \frac{Δ {N}_{m}}{\vert \frac{\partial {N}_{m}}{\partial η} \vert} )}^{2} ,$$

where Δηₘ and ΔNₘ denote the standard deviation of ηₘ and Nₘ after m interactions, respectively. As a figure of merit of multi-pass microscopy, the reduction in variance FOM=(Δη₁/Δηₘ)² is calculated at η=π/2 and plotted in FIG. 2C. FIG. 2C indicates four pairs of data curves (e.g., calculated variance reduction curve 211 and measured variance reduction curve 212; calculated variance reduction curve 221 and measured variance reduction curve 222; calculated variance reduction curve 231 and measured variance reduction curve 232; calculated variance reduction curve 241 and measured variance reduction curve 242) corresponding to respective values of Nₘ (as specified in the expressions 211, 221, 231, 241, respectively).

In some embodiments, at constant damage and for a lossless cavity and sample, the FOM=m (see the calculated variance reduction curve (dashed lines) 212 and the measured variance reduction curve (error bars) 223 in FIG. 2C) with values of Nₘ (as specified in 221 in FIG. 2C). Note that this implies an m fold damage reduction at constant Δη. In some embodiments, the FOM can be reduced by the residual birefringence of the optical setup, reflections and misalignment. In some embodiments, a variance reduction of 11.8±0.9 dB can be observed after 25 interactions. In some embodiments, the measurement accuracy might also be limited by the total number of detectable photons, for instance if there are a limited number of photons or if the detection rate is limited by a dead time of a detector. For example, the figure of merit scales as m². In some embodiments, the corresponding measurements may yield a variance reduction of 26.1±0.8 dB after 29 interactions (see measured variance reduction curve 213 in FIG. 2C). Photon losses αₛ due to absorption, reflection or scattering in the sample (αₛ=1−tₛ=0.039 per interaction where tₛ is a sample transmission) or photon losses α_{c} in the cavity (α_{c}=1−t_{c}=0.189 per interaction where t_{c} is a cavity transmission) reduce the efficiency of multi-pass microscopy, since only Nₘ=N₁t^{m-1}α_{P}_{ₒ}_{,m}/m_{α}≦N₁α_{P}_{ₒ}_{,m}/m will be collected for operation at constant damage. Here, t=t_{c}tₛ=1−α and m_{α}<m is a mean number of interactions of a photon with the sample before it is either out-coupled or lost. The calculated variance reduction curve 231 and measured variance reduction curve 232 (see FIG. 2C) take into account the losses in the sample, resulting in the variance reduction of 10±0.8 dB at 23 interactions. The calculated variance reduction curve 241 and measured variance reduction curve 242 (see FIG. 2C) take into account the combined losses in sample and optics, resulting in the variance reduction of 5.4±0.8 dB at 5 interactions.

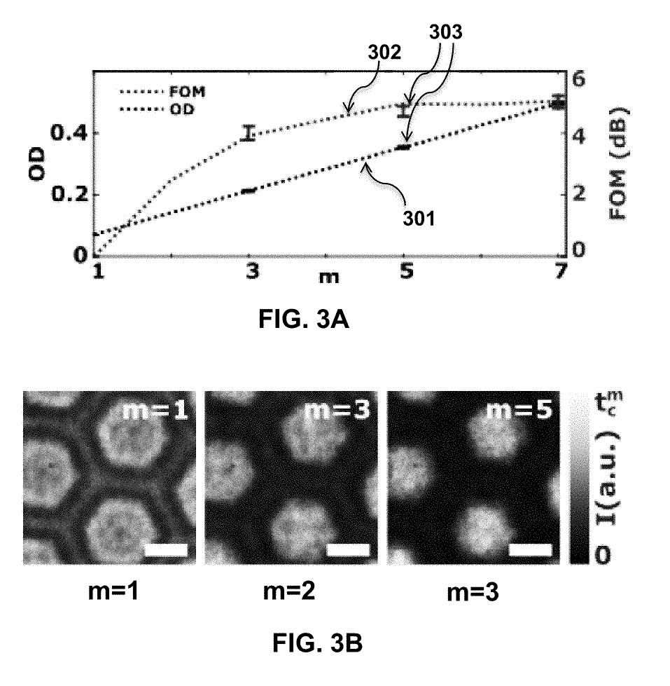

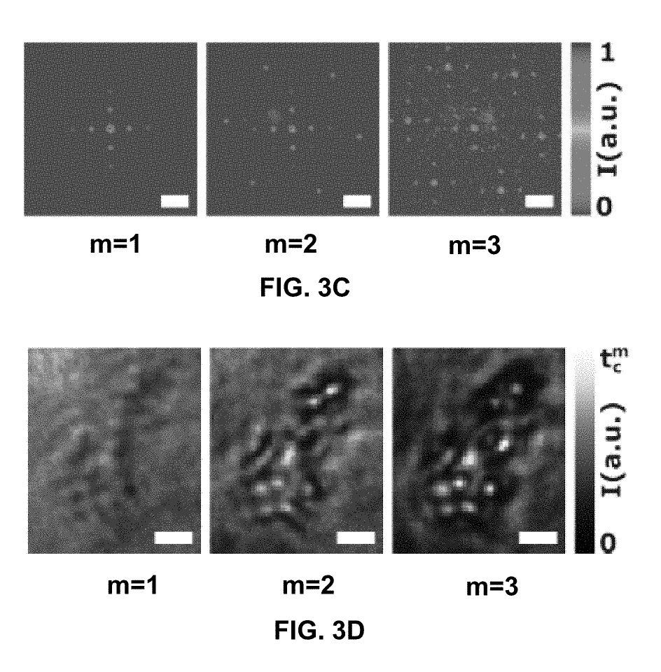

Transmission measurements can also benefit from multi-passing if the total losses due to the sample and the cavity are small. FIG. 3A-FIG. 3D illustrate contrast enhancement in absorption microscopy and diffraction. More particularly, FIG. 3A illustrates the optical density and variance reduction with different numbers of interactions in photon counting measurements of an optical density filter, according to some embodiments. FIG. 3B illustrates multi-pass microscopy images of hexagonal hole patterns in a carbon membrane, according to some embodiments. FIG. 3C illustrates multi-pass microscopy images of diffraction patterns in a carbon membrane, according to some embodiments. FIG. 3D illustrates multi-pass micrographs of embryonic kidney 293T cells, according to some embodiments. The scale bar is 20 μm, 10 mm⁻¹ and 20 μm for FIG. 3B, FIG. 3C and FIG. 3D, respectively.

FIG. 3A illustrates photon counting measurements of an optical density (OD) filter showing a linear growth 301 of the optical density with m and a variance reduction 302 at constant damage of up to 5±0.2 dB. The error bars 303 provide a statistical standard deviation obtained from bootstrapping. In some embodiments, measuring the optical density (OD) of a spatially homogeneous sample shows signal amplification and a variance reduction, as shown in FIG. 3A (at constant damage). In some embodiments, due to the absorption of the sample, there is no further decrease in variance when the number of interactions is increased to more than 7.

In some embodiments, the imaging capabilities and contrast enhancement capabilities of the setup can be exemplified at microfabricated grating structures as well as at embryonic kidney 293T cells. FIG. 3B illustrates contrast enhancement in multi-pass micrographs of a micro-structured carbon membrane (normalized to t_{c}^{m}, where t_{c}=1−α_{c} and α_{c} is the cavity induced loss in between two interactions) as well as in the respective diffraction patterns as shown in FIG. 3C (normalized to the central peak). FIG. 3B shows multi-pass (m=1, 3, 5) microscopy images of a hexagonal hole pattern in a carbon membrane. In some embodiments, the resolution of the microscope may be approximately 5 micrometers (μm) due to the finite numerical aperture of the employed lenses (e.g., f=50 millimeters (mm)). In some embodiments, the photon loss due to the carbon membrane can be amplified by multiple passes, which leads to a significant contrast enhancement. This also becomes apparent in the images shown in FIG. 3C, which were taken in the Fourier plane (e.g., the plane 80 in FIG. 1) of the imaging optics after the out-coupling mirror (e.g., the mirror 22). In some embodiments, while the single pass image is dominated by the diffraction pattern caused by the four-sided copper support structure of the carbon membrane, the hexagonal symmetry due to the holes in the membrane can become clearly visible after multiple interactions.

FIG. 3D provides multi-pass micrographs of embryonic kidney 293T cells, where a clear contrast enhancement is observed. In some embodiments, while cells and other phase objects are hardly visible in single pass bright-field microscopy, the outline of single cells becomes clearly visible in multi-pass microscopy images. In some embodiments, both absorption and phase shifts can be taken into account in the analysis of such images.

Multi-pass microscopy is a technique for signal amplification. In some embodiments, multi-pass microscopy allows for optimal parameter estimation in the presence of noise sources that are not significantly amplified by the multi-passing (such as shot-noise or read-noise). While the proof-of principle experiments shown rely on temporal post-selection, in some embodiments, a fast electro-optical switch such as a Pockels cell may be employed instead, to out-couple all light at once. Multi-pass microscopy will then benefit applications that are sensitive to photo-induced damage, such as live cell microscopy or the label-free detection of single proteins. In some embodiments, the multi-pass microscopy technique allows for improved measurement accuracy, if the total number of detected particles is limited either by the detector or by a limited number of probe particles, such as at wavelengths where there are no high intensity light sources, or in measurements that involve massive particles as probe particles (e.g., electron or ion microscopy, or measurements involving anti-matter). In some embodiments, multi-passing electron microscopy can avoid sample damage that can limit spatial resolution when imaging biological specimens.

Two different laser systems were used for the experiments described above. For the data in FIG. 3A-FIG. 3D, a titanium sapphire was used (Venteon, 10 femtoseconds (fs) pulse width, 5 nanojoules (nJ) per pulse, 100 megahertz (MHz) repetition rate, spectrally centered at wavelength λ=780 nanometers (nm)). A lower repetition rate laser was used for the data in FIG. 2A-FIG. 2C to allow for more interactions before the advent of the consecutive laser pulse. A laser diode (783 nm) was driven with fast voltage pulses. Pulse widths<1 ns at a peak power of about 100 milliwatts (mW) were achieved. The repetition rate was controlled using a direct digital synthesizer (Novatech 409B) set to 25 MHz.

For the first laser system (data of FIG. 3A-FIG. 3D), the pulses were spectrally filtered (Semrock LL01-810-12.5) to reduce an effect of chromatic aberrations in the self-imaging cavity. While this broadened the temporal width of the pulses, the pulses are still short compared to the cavity round trip time. A resonantly driven electro-optic modulator was used to reduce the laser repetition rate to 50 MHz with an extinction ratio of about 16 dB. The linearly polarized light passed through a polarization beamsplitter cube and a quarter waveplate before it was coupled into a polarization maintaining SMF. Alignment of the self-imaging cavity was done element by element (e.g., starting from the out-coupling mirror) by maximizing the light that was back-reflected into the SMF. A quarter wave plate and the beamsplitter then act as an optical isolator and the reflected light was detected using a photodiode.

The quartz-silica depolarizer was of a wedged plate of optical quartz cemented to a wedged plate of synthetic fused silica (OptoSigma DEQ 2S). The quartz crystal was cut and oriented such that it had the fast axis at a 45 degree angle with respect to the polarization of the incoming beam. In some embodiments, the fused silica wedge has negligible birefringence and avoids beam deviation. The Jones matrix of the quartz crystal can be written as:

$$J = ( \begin{matrix}cos \frac{η}{2} & i sin \frac{η}{2} \\ i sin \frac{η}{2} & cos \frac{η}{2}\end{matrix} ) ,$$

where η is the phase retardance due to the birefringence of the crystal. The retardance η is proportional to a thickness of the crystal, which varies spatially, as the crystal is cut with a wedge angle of α˜2 degrees: η˜αΔxΔn/λ, where Δn˜0.009 is the difference in index of refraction of light polarized along the fast or slow axis of the crystal. Horizontally polarized light

$$\vert H 〉 = {E}_{0} ( \begin{matrix}1 \\ 0\end{matrix} )$$

entered the multi-pass microscope (I₀=|E₀|² is the intensity of the incoming light; E₀ is the complex amplitude of the electric field), interacted with the quartz crystal m times and was projected onto the vertical polarization axis and detected. This can be written as

$${I}_{det} = {\vert {E}_{0} ( \begin{matrix}0 & 0 \\ 0 & 1\end{matrix} ) {( \begin{matrix}cos \frac{η}{2} & i sin \frac{η}{2} \\ i sin \frac{η}{2} & cos \frac{η}{2}\end{matrix} )}^{m} ( \begin{matrix}1 \\ 0\end{matrix} ) \vert}^{2} = {I}_{0} {sin}^{2} \frac{m η}{2} .$$

To assess the single-pass shot-noise limit, the spatially resolved photon counting capabilities of the ICCD camera were exploited (note, however, that these capabilities are not needed to benefit from multipass microscopy).

For the retardance measurements in FIG. 2A-FIG. 2C, the exposure was chosen such that 150 photons were detected per image. There were fewer than 1 dark counts per image. For each value of m, 10,000 images were acquired. To analyze the statistics, Nₘ photons were randomly chosen from the acquired data. This restricted dataset was then bootstrapped 100 times to assess the variance of the measured retardance, and the process repeated 50 times to assess the standard deviation of the variance.

For the OD measurements in FIG. 3A, the technique used was similar, but with a constant exposure instead of a constant number of photons per image. To show the variance reduction at constant damage, 2000/mₐ images were randomly chosen. This restricted dataset was then bootstrapped 2000 times to assess the variance of the measured optical density, and the process repeated 50 times to assess the standard deviation of the variance.

Next, measurement error is discussed. Assume Nₘ photons are used to probe the transmission of a sample. In some embodiments, after m bounces, all photons may be out-coupled from the cavity and detected with a photon counting detector. In some embodiments, without the sample, N_{wo}=t_{c}^{m}Nₘ photons can be detected. In some embodiments, uncorrelated repetitions of the measurement of N_{wo} can give a standard deviation of Δ_{N}_{_{wo}}=\sqrt{N_{wo}}. In some embodiments, with a partially absorptive sample in the setup, N_{w}=t^{m}Nₘ photons can be detected with a standard deviation of Δ_{N}_{_{w}}=\sqrt{N_{w}}. In some embodiments,

$${t}_{s} = {( \frac{{N}_{w}}{{N}_{wo}} )}^{1 / m}$$

and error propagation can yield a standard deviation of the measured sample transmission of

$${Δ}_{{t}_{s}} = \frac{{t}_{s}}{m} \sqrt{\frac{1}{{N}_{m} {t}_{c}^{m}} ( 1 + \frac{1}{{t}_{s}^{m}} )} .$$

In some embodiments, the standard deviation can be calculated as a function of m for constant damage. This implies that the number of in-coupled photons N_{m,0} can be a function of m, such that the number of absorbed photons Dₘ is independent of m. In some embodiments, for a symmetric setup, in which the cavity losses are substantially the same on both sides of the sample, Dₘ=N_{0,m}Σᵢ₌₁^{m}t_{c}ⁱtₛⁱ⁻¹(1−tₛ), and Dₘ=D₁ can yield

$$\frac{{N}_{1}}{{N}_{0 , m}} = \frac{1 - {t}^{m}}{1 - t} and \frac{{Δ}_{{t}_{s} , 1}}{{Δ}_{{t}_{s} , m}} = m \sqrt{\frac{( 1 - t ) ( 1 + {t}_{s} ) {t}^{m - 1}}{( 1 - {t}^{m} ) ( 1 + {t}_{s}^{m} )}} .$$

In some embodiments, for mα<<1 this can yield a figure of merit of multi-pass absorption microscopy

$${( \frac{{Δ}_{{t}_{s} , 1}}{{Δ}_{{t}_{s} , m}} )}^{2} = m$$

that scales linearly with m, just as it did for the retardance measurements.

When studying living samples, it might be more interesting to look at the damage reduction at constant standard deviation (_{Δts,1}=Δ_{ts,m}, but Dₘ≠D₁), which yields

$$\frac{{D}_{1}}{{D}_{m}} = {( \frac{{Δ}_{{t}_{s} , 1}}{{Δ}_{{t}_{s} , m}} )}^{2}$$

and scales with m for mα<<1.

Spatial descriptions, such as “above,” “below,” “up,” “left,” “right,” “down,” “top,” “bottom,” “vertical,” “horizontal,” “side,” “higher,” “lower,” “upper,” “over,” “under,” and so forth, are indicated with respect to the orientation shown in the figures unless otherwise specified. It should be understood that the spatial descriptions used herein are for purposes of illustration only, and that practical implementations of the structures described herein can be spatially arranged in any orientation or manner, provided that the merits of embodiments of this disclosure are not deviated by such arrangement.

As used herein and not otherwise defined, the terms “substantially,” “substantial,” “approximately” and “about” are used to describe and account for small variations. When used in conjunction with an event or circumstance, the terms can encompass instances in which the event or circumstance occurs precisely as well as instances in which the event or circumstance occurs to a close approximation. For example, when used in conjunction with a numerical value, the terms can encompass a range of variation of less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%.

Additionally, amounts, ratios, and other numerical values are sometimes presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified.

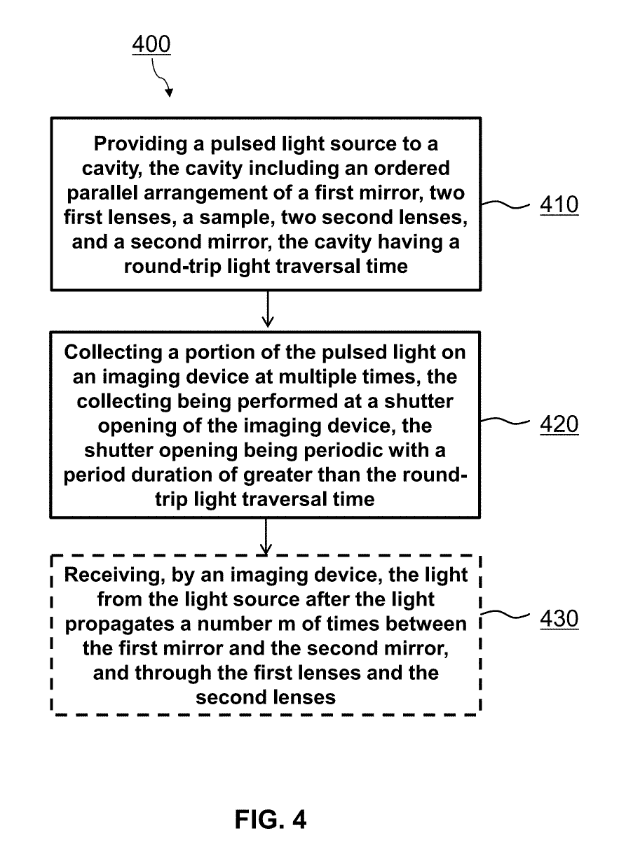

FIG. 4 is a flowchart showing operations of an example multi-pass microscopy method 400 according to some embodiments.

Referring to FIG. 1 and FIG. 4, in some embodiments, the method 400 includes providing a pulsed light from a light source 11 to a cavity 40 (step 410 in FIG. 4). In some embodiments, the cavity 40 may include an ordered parallel arrangement of a first mirror 21, a plurality of (e.g., two) first lenses 31, 32, a sample 50, a plurality of (e.g., two) second lenses 33, 34, and a second mirror 22. In some embodiments, the cavity 40 may have a round-trip light traversal time. In some embodiments, the method 400 includes collecting a portion of the pulsed light on an imaging device (e.g., the ICCD camera 90) at multiple times (step 420 in FIG. 4). In some embodiments, the collecting may be performed at a shutter opening of the imaging device 90. In some embodiments, the shutter opening may be periodic with a period duration of greater than the round-trip light traversal time. In some embodiments, the imaging device 90 may be positioned adjacent to the second mirror 22. In some embodiments, the collecting the portion of the pulsed light may include receiving, by the imaging device 90, the light from the light source 11 after the light propagates a number m of times between the first mirror 21 and the second mirror 22, and through the first lenses 31, 32 and the second lenses 33, 34 (step 430 in FIG. 4). In some embodiments, a distance (e.g., 2f) between the two first lenses 31, 32 may be approximately equal to twice a distance (e.g., f) between the first mirror 21 and one lens 31 of the two first lenses. In some embodiments, a distance (e.g., 3f) between the first mirror 21 and the other lens 32 of the two first lenses may be approximately three times the distance (e.g., f) between the first mirror 21 and the one lens 31 of the two first lenses. In some embodiments, a distance (e.g., f) between a prospective location of the sample 50 and one lens 32 of the first lenses may be approximately equal to a distance (e.g., f) between the first mirror 21 and the other lens 31 of the first lenses. In some embodiments, temporal widths of pulses of light from the light source 11 may be shorter than the round-trip light traversal time of the cavity 40.

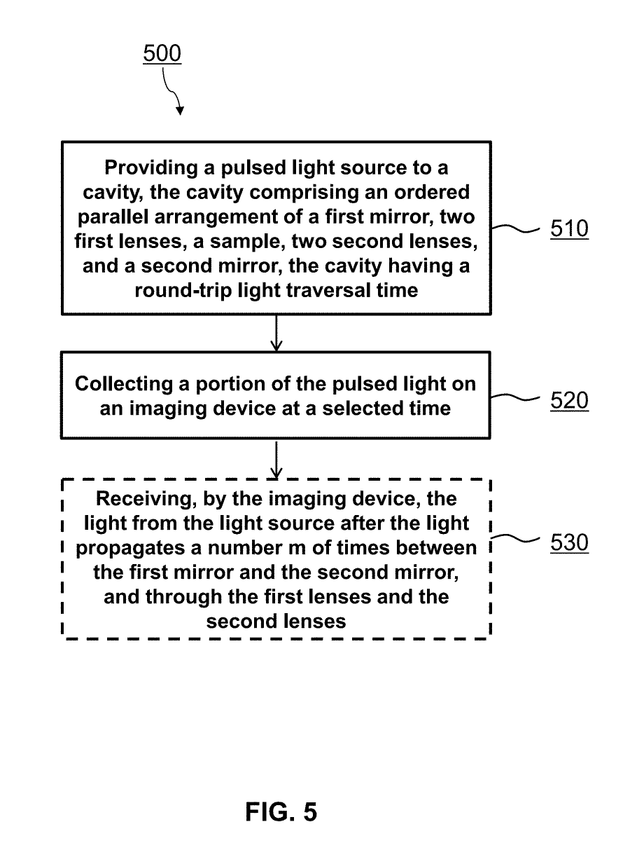

FIG. 5 is a flowchart showing operations of an example multi-pass microscopy method 500 according to some embodiments.

Referring to FIG. 1 and FIG. 5, in some embodiments, the method 500 includes providing a pulsed light from a light source 11 to a cavity 40 (step 510 in FIG. 5). In some embodiments, the cavity 40 may include an ordered parallel arrangement of a first mirror 21, a plurality of (e.g., two) first lenses 31, 32, a sample 50, a plurality of (e.g., two) second lenses 33, 34, and a second mirror 22. In some embodiments, the cavity 40 may have a round-trip light traversal time. In some embodiments, the method 500 includes collecting a portion of the pulsed light on an imaging device (e.g., the ICCD camera 90) at a selected time (step 520 in FIG. 5). In some embodiments, the imaging device 90 may be positioned adjacent to the second mirror 22. In some embodiments, the collecting the portion of the pulsed light may include receiving, by the imaging device 90, the light from the light source 11 after the light propagates a number m of times between the first mirror 21 and the second mirror 22, and through the first lenses 31, 32 and the second lenses 33, 34 (step 520 in FIG. 5). In some embodiments, a distance (e.g., 2f) between the two first lenses 31, 32 may be approximately equal to twice a distance (e.g., f) between the first mirror 21 and one lens 31 of the two first lenses. In some embodiments, a distance (e.g., 3f) between the first mirror 21 and the other one 32 of the two first lenses may be approximately three times the distance (e.g., f) between the first mirror 21 and the one lens 31 of the two first lenses. In some embodiments, a distance (e.g., f) between a prospective location of the sample 50 and one lens 32 of the first lenses may be approximately equal to a distance (e.g., f) between the first mirror 21 and the other one 31 of the first lenses. In some embodiments, temporal widths of pulses of light from the light source 11 may be shorter than the round-trip light traversal time of the cavity 40.

While the present disclosure has been described and illustrated with reference to specific embodiments thereof, these descriptions and illustrations are not limiting. It should be understood by those skilled in the art that various changes may be made and equivalents may be substituted without departing from the true spirit and scope of the present disclosure as defined by the appended claims. The illustrations may not necessarily be drawn to scale. There may be distinctions between the artistic renditions in the present disclosure and the actual apparatus due to manufacturing processes and tolerances. There may be other embodiments of the present disclosure which are not specifically illustrated. The specification and the drawings are to be regarded as illustrative rather than restrictive. Modifications may be made to adapt a particular situation, material, composition of matter, method, or process to the objective, spirit and scope of the present disclosure. All such modifications are intended to be within the scope of the claims appended hereto. While the methods disclosed herein have been described with reference to particular operations performed in a particular order, it will be understood that these operations may be combined, sub-divided, or re-ordered to form an equivalent method without departing from the teachings of the present disclosure. Accordingly, unless specifically indicated herein, the order and grouping of the operations are not limitations.

Thus has been described a multi-pass microscopy technique providing for reduced image noise and low light implementations.

1. A measurement system, comprising:
a focused light source;
a first mirror positioned on a first side of a sample and configured to receive light from the light source;
a plurality of first lenses positioned between the first mirror and the sample;
a second mirror positioned on a second side of the sample;
a plurality of second lenses positioned between the second mirror and the sample; and
an imaging device adjacent to the second mirror and configured to receive the light from the light source after the light propagates a number m of times between the first mirror and the second mirror, and through the first lenses and the second lenses.

2. The measurement system of claim 1, wherein the plurality of first lenses are two first lenses, and a distance between the two first lenses is approximately equal to twice a distance between the first mirror and one of the two first lenses.

3. The measurement system of claim 2, wherein a distance between the first mirror and the other of the two first lenses is approximately three times the distance between the first mirror and the one of the two first lenses.

4. The measurement system of claim 1, wherein a distance between a prospective location of the sample and one of the first lenses is approximately equal to a distance between the first mirror and another of the first lenses.

5. The measurement system of claim 1, further comprising a cavity comprising the first mirror, the second mirror, the first lenses and the second lenses,
wherein the light source is a pulsed light source, and temporal widths of pulses of light from the light source are shorter than a round-trip time of light traversing the cavity.

6. The measurement system of claim 5, wherein the imaging device is configured to collect, at a shutter opening of the imaging device, a portion of a pulsed light on the imaging device at multiple times, the shutter opening being periodic with a period duration of greater than the round-trip time of light traversing the cavity.

7. A method, comprising:
providing a pulsed light from a light source to a cavity, the cavity comprising an ordered parallel arrangement comprising a first mirror, two first lenses, a sample, two second lenses, and a second mirror, the cavity having a round-trip light traversal time;
collecting a portion of the pulsed light on an imaging device at multiple times, the collecting being performed at a shutter opening of the imaging device, the shutter opening being periodic with a period duration of greater than the round-trip light traversal time.

8. The method of claim 7, further comprising positioning the imaging device adjacent to the second mirror.

9. The method of claim 7, wherein the collecting the portion of the pulsed light includes receiving, by the imaging device, the pulsed light from the light source after the pulsed light propagates a number m of times between the first mirror and the second mirror, and through the first lenses and the second lenses.

10. The method of claim 7, wherein a distance between the two first lenses is approximately equal to twice a distance between the first mirror and one of the two first lenses.

11. The method of claim 10, wherein a distance between the first mirror and the other of the two first lenses is approximately three times the distance between the first mirror and the one of the two first lenses.

12. The method of claim 7, wherein a distance between a prospective location of the sample and one of the first lenses is approximately equal to a distance between the first mirror and the other of the first lenses.

13. The method of claim 7, wherein temporal widths of pulses of light from the light source are shorter than the round-trip light traversal time of the cavity.

14. A method, comprising:
providing a pulsed light from a light source to a cavity, the cavity comprising an ordered parallel arrangement comprising a first mirror, two first lenses, a sample, two second lenses, and a second mirror, the cavity having a round-trip light traversal time;
collecting a portion of the pulsed light on an imaging device at a selected time.

15. The method of claim 14, further comprising:
positioning the imaging device adjacent to the second mirror.

16. The method of claim 14, wherein the collecting the portion of the pulsed light includes receiving, by the imaging device, the pulsed light from the light source after the pulsed light propagates a number m of times between the first mirror and the second mirror, and through the first lenses and the second lenses.

17. The method of claim 14, wherein a distance between the two first lenses is approximately equal to twice a distance between the first mirror and one of the two first lenses.

18. The method of claim 17, wherein a distance between the first mirror and the other of the two first lenses is approximately three times the distance between the first mirror and the one of the two first lenses.

19. The method of claim 14, wherein a distance between a prospective location of the sample and one of the first lenses is approximately equal to a distance between the first mirror and the other of the first lenses.

20. The method of claim 14, wherein temporal widths of pulses of light from the light source are shorter than the round-trip light traversal time of the cavity.
